(19) United States
(12) Patent Application Publication
(10) Pub. No.: US 2013/0339980 A1
(43) Pub. Date: Dec. 19, 2013

(54) COMPOSITE APPLICATION ENABLING WORKFLOW BETWEEN UNMODIFIED CONSTITUENT APPLICATIONS

(71) Applicants: Omer Meshar, Herzlia (IL); Gila Bar, Zur Moshe (IL); Mike Karlskind, Stow, MA (US); Danny Korach, Kfar Saba (IL); Israel Beniaminy, Ramat Gan (IL); Moshe Ben-Bassat, Zur Moshe (IL)

(72) Inventors: Omer Meshar, Herzlia (IL); Gila Bar, Zur Moshe (IL); Mike Karlskind, Stow, MA (US); Danny Korach, Kfar Saba (IL); Israel Beniaminy, Ramat Gan (IL); Moshe Ben-Bassat, Zur Moshe (IL)

(73) Assignee: ClickSoftware Technologies Ltd, Petach Tikva (IL)

(21) Appl. No.: 13/916,590

(22) Filed: Jun. 13, 2013

Related U.S. Application Data
(60) Provisional application No. 61/659,441, filed on Jun. 14, 2012.

(51) Int. Cl. G06F 9/54

(52) U.S. Cl. CPC G06F 9/544; G06F 9/541
USPC 719/312

(57) ABSTRACT

Embodiments described herein enable information sharing between multiple software applications in a way that supports seamless workflow when a user interacts with these applications, even when these applications were not originally designed to coexist within the same workflows. The embodiments enable each application to initiate processes, create notifications, and automate actions based on information from all the connected applications. The application programming interface (API) of each application communicates with a dedicated delegate, and the delegates of the different applications interact with each other by reading and writing into a shared hardware and software environment. The delegates, along with the applications and the shared environment, form a composite application.

### RELATED APPLICATION

This application claims priority under 35 U.S.C. §119(e) to U.S. Provisional Application No. 61/659,441, filed Jun. 14, 2012, which is hereby incorporated by reference in its entirety.

### BACKGROUND

Workplaces now implement more than ever increasing numbers of software applications to track daily activities of the employees. For example, a single employee of an organization may typically need to utilize a task management application to see his/her assigned task and then report on its completion, and the same employee may also need to utilize a time tracking application to enter a task identifier and start and stop times associated with the particular task reported on using the first application.

The present inventors noticed that regularly multiple applications requested the same data. The task management application and the time tracking application both requested the time that a particular employee completed a particular task. The inventors realized that, it would be useful if the second application simply retrieved the information (such as completion time) from the storage of the first application. However, the applications had to be modified to provide this functionality. Each application involved had to be modified to provide information anticipated in advance.

The scenario in the preceding paragraph is one of many examples in which it would be useful for applications to be able to automatically share data. The inventors knew of no conventional way for a user to decide which application he/she desired would exchange information and then enable that information exchange without needing to modify the applications themselves. Accordingly, the inventors determined that workplace efficiency would increase if it were possible to automate the data exchange between a user's applications to reduce the instances in which the user needed to enter the same information repeatedly.

### SUMMARY

The present inventors developed a way to automate the data exchange between a user's applications to reduce the instances in which the user needed to enter the same information repeatedly. Embodiments of the invention apply context awareness to automatically retrieve from storage information that a user may desire.

The invention may be embodied as a computing device hosting a composite application. The computing device includes a storage device, first and second applications, first and second delegates, and a processor. The storage device has a shared context data area that receives data from at least one utility that functions independently of the composite application. The first application has a first API and the second application has a second API, and the first and second applications reside on the storage device. The first delegate interfaces with the first API, and the second delegate interfaces with the second API. The first and second delegates reside on the storage device and store data on and retrieve data from the shared context data area. The processor activates the first and second delegates to apply context awareness to determine actions based on data stored in the shared context data area and to suggest the actions to a user, to execute the actions automatically, or both. The shared context data area, the first and second applications, and the first and second delegates are components of the composite application.

The invention may also be embodied as a computing device hosting a composite application and including a storage device, at least a first application, at least a first delegate, and a processor. The storage device has a shared context data area that receives data from the at least one utility that functions independently of the composite application. The at least the first application has a first API and resides on the storage device. The at least the first delegate with at least the first API and resides on the storage device and stores data on and retrieves data from the shared context data area. The processor activates at least the first delegate to apply context awareness to determine actions based on data stored in the shared context data area and to suggest the actions to a user, to execute the actions automatically, or both. The shared context data area, the first application, and the first delegate are components of the composite application.

Embodiments of the present invention are described in detail below with reference to the accompanying drawings, which are briefly described as follows:

### BRIEF DESCRIPTION OF THE DRAWINGS

The invention is described below in the appended claims, which are read in view of the accompanying description including the following drawings, wherein:

FIG. 1 illustrates the invention embodied as computing device;

FIG. 2 provides a more detailed illustration of the embodiment of FIG. 1;

FIG. 3 provides an illustration of an alternate embodiment;

FIG. 4 illustrates the internal structure of a delegate;

FIG. 5 illustrates another embodiment of the invention;

FIG. 6 illustrates still another embodiment of the invention; and

FIG. 7 illustrates yet another embodiment of the invention.

### DETAILED DESCRIPTION

The invention summarized above and defined by the claims below will be better understood by referring to the present detailed description of embodiments of the invention. This description is not intended to limit the scope of claims but instead to provide examples of the invention.

Embodiments of the present invention enable information sharing between multiple software applications in a way that supports seamless workflow when a user interacts with these applications. The embodiments enable each application to initiate processes, create notifications and automate actions based on information from all the connected applications. The application programming interface (API) of each application communicates with a dedicated delegate, and the delegates of the different applications interact with each other by reading and writing into a shared hardware and software environment. The delegates, along with the applications and the shared environment, form a composite application.

One exemplary use of such composite application is to activate the delegates to apply context awareness while the composite application “accompanies” the user throughout the workday. Accordingly, the composite application predicts business and personal needs and acts on them proactively, similarly to the classic notion of a (human) English butler. The user or a third party does not need specialized know-how to form the composite application.

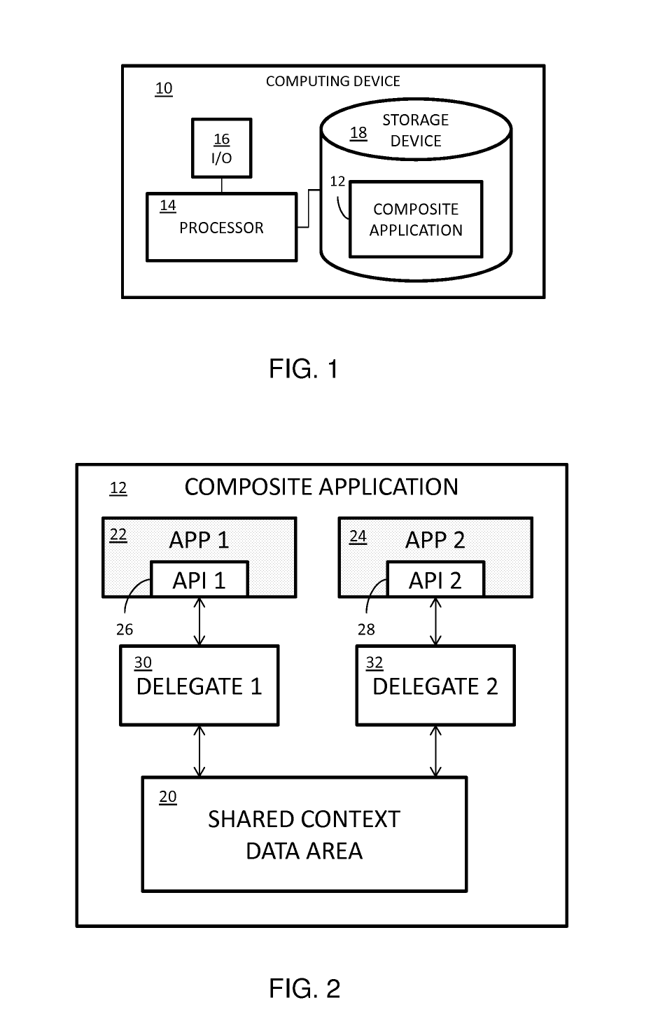

FIG. 1 illustrates an exemplary embodiment of the invention. A computing device 10, such as a personal computer, tablet, or smartphone, as non-limiting examples, hosts a composite application 12 as follows: The computing device 10 has a processor 14 that interacts with a user via an input/output mechanism 16. The input circuitry of the input/output mechanism 16 may include a keyboard, cursor movement device (such as a mouse, trackball, touchpad, and the like), microphone, and similar accessories, and the output device of the input/output mechanism 16 may include a display screen or speakers, all as non-limiting examples. The processor 14 also interacts with a storage device 18, which may be one of many different types of non-transitory memory, such as a hard disk drive, a flash memory SSD, a compact disk, a DVD, USB (Universal Serial Bus) flash drive, and the like.

The storage device 18 has a shared context data area 20 that is configured to receive data from at least one utility that is operative to function independently of the composite application 12. An example of such an independent utility is global positioning system (GPS) hardware and its accompanying GPS software, which produces position data and corresponding time data for each position datum recorded. This GPS data is stored in the shared context data area 20 in exemplary embodiments. Other examples of independent utilities that store data in the shared context data area 20 storage device 18 include those that measure sound level, light level, temperature, and acceleration, and those that sense Internet connectivity. The data these utilities provide are categorized as “environment context.” Other utilities include those that monitor current and upcoming tasks, identity and location of co-workers, availability of parts required for the task, overall workload (such as, this a very busy day or a lightly loaded day. The data these utilities provide are categorized as “business context.”

FIG. 2 provides a more detailed illustration of the composite application 12 of the embodiment of FIG. 1. The composite application 12 includes two conventional applications, a first application 22 and a second application 24, but alternate embodiments may have different numbers of applications. The first application 22 has a first API 26 and the second application 24 has a second API 28. Both the first and second applications 22, 24 reside on the storage device 18. The composite application 12 also includes a first delegate 30 interfacing with the first API 26 and a second delegate 32 interfacing with the second API 28. The first and second delegates 30, 32 reside on the storage device 18, and they store data on and retrieve data from the shared context data area 20.

The processor 14 activates the first and second delegates 30, 32 to apply context awareness to determine actions based on data stored in the shared context data area 20 and to suggest the actions to the user, to execute the actions automatically, or both. Typically, the code that implements the delegates' application of context awareness resides within the delegates. Collectively, the shared context data area 20, the first and second applications 22, 24, and the first and second delegates 30, 32 form the composite application 12.

One example of a delegate applying context awareness occurs with an employee in an organization using the following three applications in a single morning: a task management application, a time tracking application, and a sales application. The organization dispatches the employee to service a customer at the customer's site. Based on the data the employee receives from the task management application regarding the assignment, the employee executes the job, and at the end he needs to indicate when the task is completed. The employee is also expected to update the time tracking application so the company can charge the customer appropriately. The employee is also responsible for opening and running a sales application to assist him in offering appropriate products to the customer, the sales application suggesting products based in part on the task being performed.

In this example, the three applications acting independently track and record some of the same information. The task management application tracks and records (interacts with) the following information/topics (at least):

Who does the work (task) (#1)

Who receives the results of the work (#2)

What work is done (#3)

Where is the work done (#4)

When is the work done (#5)

(Topic item numbers are in parentheses.) The time tracking application interacts with some of the same topics as follows:

Who does the work (#1)

When the work is done (#5)

The sale application interacts with these topics:

Who receives the results of the work (#2)

What is sold (#6)

Each of the task management application, the time tracking application, and the sales application records information for a different department of the organization, specifically, the service department, accounting department, and the sales department, respectively. Nonetheless, they share multiple topics. Without the present invention, the employee would need to repeat entry of the shared information, because each application is separate and stands alone, and there is no sharing of information, nor is there any basis for common data or a workflow that involves multiple applications. For example, when the employee is using the task management application, the application keeps track of the current task, including the identity customer for that task. However, when the employee switches to the separate independent sales application, the employee will need to enter again the identity of the customer, due to the lack of data sharing. This is just one example of the many items of information that can be shared between applications, thus leading to a much more efficient and much less error-prone work flow. To such work flow, embodiments of the composite application of the present invention enable a user to interact with the three applications more efficiently.

To enable conventional stand-alone applications 22, 24 to share topics as discussed above, the embodiment of FIGS. 1 and 2 places the information relating to this topic in the shared context data area 20 that all the applications may access (optionally subject to privacy and data-access authorization rules). This part of the shared context data area 20 may be labeled the “business context” portion. Apart from operational information such as the example topics provided above, the shared context data area 20 may also have an “environment context” portion, which supports a large amount of information that the computing device gathers from the user's (a technician, in this example) immediate environment—for example, location and speed (e.g., via GPS), noise level, lighting level, temperature, availability of fast and/or cheap internet access. Furthermore, the context also supports a large number of items that the computing device (a mobile device in this example) retrieves from remote systems—for example, location of other technicians in the team, current service delivery metrics such as workload and number of pending tasks, or services and products that the organization's management wants the technician to try selling.

The shared context data area 20 embodies a shared context that has the following characteristics:

The shared context has a pre-defined set of terms, data definitions, process logic and links between different types of data (as might be represented as a software class diagram), so that the delegates interacting with this context have a “common language,” that is, they are ready to exchange data about such topics as mentioned in the above examples using the pre-defined terms and data.

The shared context is a mechanism not just for sharing data but also for collaboration between the delegates. The delegates receive notifications when data items in their “topics of interest” are changed. In the above example, when the technician uses the task management application to mark the fact that a certain task has started, this data-change event triggers the delegate for the time tracking application, causing that delegate to insert the event into the timesheet report, and—depending on task type—also into the bill to be sent later to the customer. A second example is the change of speed (part of the environment items in the shared context) affecting the way applications interact with the user. For example, when the speed indicates that the user is in a moving vehicle, non-urgent notifications will be delayed until the speed drops.

Associated with the shared data are groups of selected data items (parameters), and certain business-relevant ranges of values of these parameters, or combinations of parameter values (states). For example, a task may have the data item “expected start time” associated with it, and as is common in such software, this data item is defined as having the “date+time” data type. However, it may be more business-relevant to look not at the specific expected time, but at its relationship to another data item, specifying the promised task execution time: This state is defined by considering both the above data items, checking whether the task falls into, for example, one of the following named states: “On time,” “Slightly late,” or “Excessively late,” where each state is defined by a numerical range of values defined by one of the delegates or the shared data's management software.

The shared context includes software monitors that watch for changes in the above-described parameters and/or the states associated with them. When these changes are beyond threshold values, they trigger a conclusion that leads to action. An action could be a recommendation for action to be approved by user, or automatic action taken by the software. The delegates described in this invention define these monitors as a notification mechanism “waking up” (activating) a delegate when the specified change or state occurs.

The shared context can also be used to perform actions such as initiating user interactions (e.g., beeping to get user's attention or making a recommendation and requesting the user to approve), initiating communications (e.g., sending an SMS or an e-mail), printing an invoice, and starting additional applications.

The shared context is organized around common business objects, attributes and characteristics. Such may be termed “W dimensions,” where “W” stands for answers to such questions as Who, What, When, Where, with What etc. Thus, for example, people are represented as part of the “Who” dimension, and may be further divided into employees, customers, contractors etc.

As can be seen from the lists above, the topics of interests are shared by the applications as follows:

| | Application | | |
|---|---|---|---|
| Topic | Task | Time | |
| (by number) | Management | Tracking | Sales |
| 1 | • | • | |
| 2 | • | | • |
| 3 | • | | |
| 4 | • | | |
| 5 | • | • | |
| 6 | | | • |

In this example, assume the following requirements for the time tracking application and the sales application given that the task management application is operating:

The time tracking application reflects the worker's activities, including when each task was started and completed.

The sales application, when opened, defaults to a mode that guides a sale to the customer at whose home the worker is currently located.

The sales application must ensure that the worker obtains the customer's signature on any open order (or alternatively cancel the order) before the worker leaves the customer's home.

An application composition environment (a “studio”) fulfills these requirements automatically, and a human application builder only needs to bring the applications into the environment (for example, by dragging icons on a desktop to a designated area). The human application builder does not need to modify the applications.

Accordingly, with the task management application already running, information regarding the following topics is available and stored into the shared context:

Who does the work (task) (#1)

Who receives the results of the work (#2)

What work is done (#3)

The time tracking application monitors for changes in topic #3, written to the shared context by the task management application, and, when it notices such a change, it automatically records the start of a new task and the associated start time.

A worker at a customer's house often opens a sales application, for example, to order a new toner cartridge for the customer after servicing his printer. In the present scenario, when the worker opens his sales application, it automatically extracts, out of the shared context, the information for topics #1 and #2 from the task management application.

Events for both the time tracking application and the sale application occur when the worker reports the end of the task into the task management application. Such action appears as a change in topic #3. The sales application notices the change and automatically presents to the worker the sales form (already opened) and prompts the worker to complete the form. The time tracking application also notices the change in topic #3 recorded in the time tracking application and records the end time in its own records.

Note that a developer making the composite application did not have to specify the activities described above. Also notice that the applications do not need to be developed in advance to be ready for the scenario where they are inserted into the same composite application. For example, the sales application does not need to know that a task management application exists. All it needs to know is that it should monitor for changes in the identity of the current customer or the equipment currently being serviced. If such changes come from another application—in our example, the task management application—it would save time for the user of the sales application; and if the sales application cannot find that information in the shared application, it would query the user to supply the information. Thus, application developers do not need to think of which other applications will co-exist with their application, and they do not need to build communication between the applications. All the communication between applications takes place indirectly via changes to the shared context.

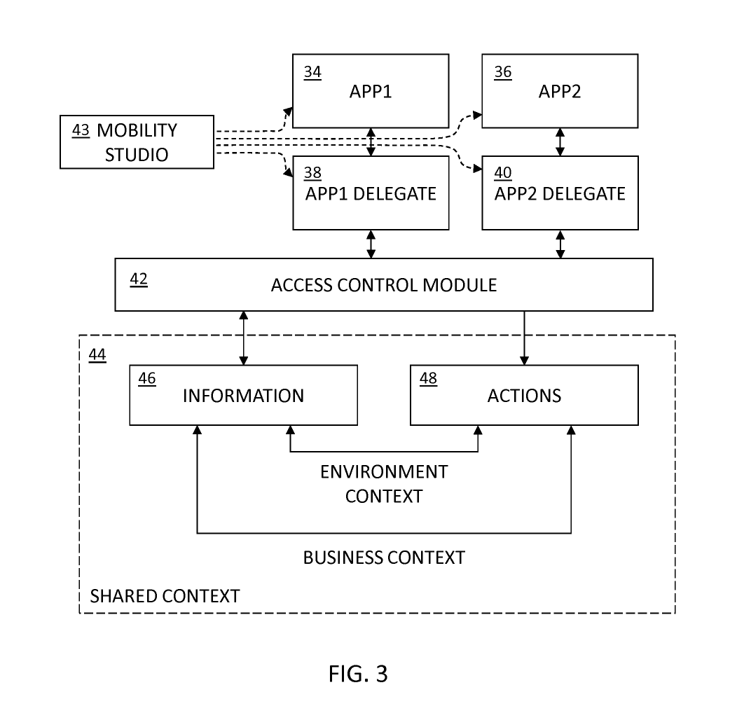

Reference is now made to FIG. 3, which provides a top-level diagram of another embodiment of the invention. Each of two applications App1 34 and App2 36 of the embodiment interface through a delegate 38, 40, respectively, with an access control module 42. The applications and the delegates are inserted in the composite application with the use of a studio 43. Here, the term “studio” refers to a software design environment which lets an operator create and configure a composite application, e.g., through the use of drag-and-drop interaction and specifying behavior via software forms and dialogs, App1 34 and App2 36 both interact, via their delegates 38, 40, with a shared context 44 which includes both business context and environment context data. As described above, another way to categorize the items in the shared context into “information 46,” that is records of interconnected business entities such as tasks, contacts etc., where contacts are linked to the tasks for which they are relevant; and “actions 48,” that is the capabilities of the computing device running the applications and the computer network in which it resides, such as sounding an alert, sending a message, or opening a new task. As mentioned above, the shared context 44 uses a common terminology for topics, business entities and actions; so that all delegates can interact without needing to be aware of which other applications and delegates will be inserted into the same composite application.

Each application App1 34 and App2 36 has its own delegate 38, 40, respectively, whis is analogous to a human butler in that the delegate takes care of achieving the application's goals. Having a dedicated delegate enables an application to be extended and integrated without changing the application itself. Such applies even for applications developed long ago and/or when the applications' developers are not accessible. Also, the core functionality of each application is separated from the interaction it needs to perform with other applications in the solution and with external components (e.g., back-office systems). Accordingly, the same application can be integrated in many different ways. Below will be described how a single delegate may work with several applications or vice versa.

A delegate has multiple functions. It selects the data that its associated application loads, e.g., a task list having just the next task to do, all night tasks of a particular engineer, or all of a team's tasks for use by a team leader. A delegate also mediates between the application's specific components and the shared context: For example, an application labeled “Today's View” gets upcoming tasks, team meetings, and personal items like doctors' appointments, because all of them display two W's (Where and When, consistent with the above explanation of the labels “W” for particular types of information) and all of them select which Where/When items to display based on a third W (Who), so that each user only sees items relevant to that user. The delegate also monitors for changes in the shared context and decides if and how the application responds to the changes. A delegate also intervenes in actions selected by the application, such as “deciding” to order an additional part. The delegate can choose how to intervene (e.g., by sending e-mail, by calling a Web Service, or by adding text to the work order) according to context (e.g., type of part, type of user—internal or outside contractor, or availability of parts management applications).

Each application has its own API, and its delegate is designed for that API, which may be specific for each application. The delegate is also designed to interact with the shared context via its pre-defined categories and terminology. The delegate is the go-between that links any application (even an application developed for a totally different environment, unaware of any context or business entities outside the application's own scope) to the shared context and to the actions. The Application does not have to “understand” that it is part of an interacting set of applications within a composite application. The application does not have to understand what other applications are doing. The application only needs an API by which its delegate can connect it to the shared context, and connect it indirectly through that context to other applications. This opens a great eco-system opportunity for adopting apps developed by anybody using any tools.

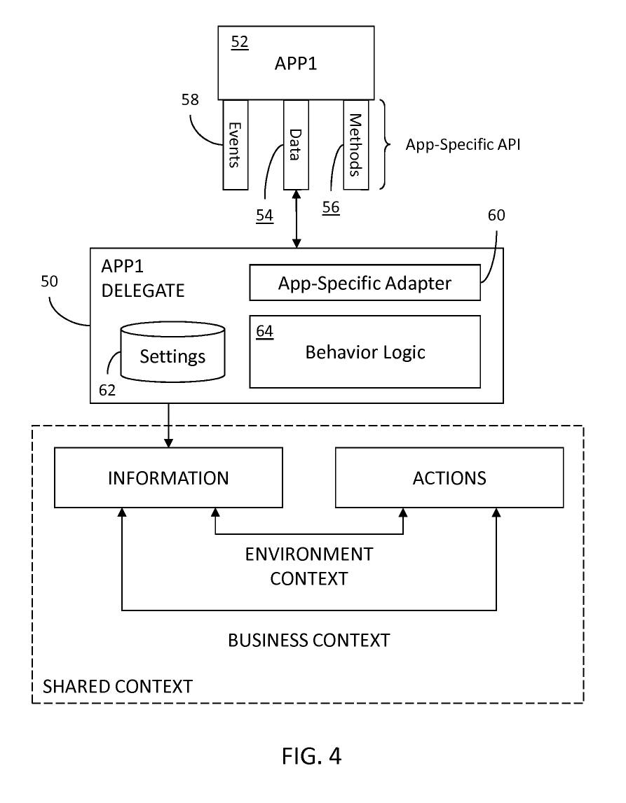

Reference is now made to FIG. 4 illustrating the internal structure of a delegate 50 and its relationship to an app-specific API 52. Commonly, an API may include a way to access and application's data, a way to activate certain parts of the application's functionality, and a way to request the application to activate a software process or message when a certain event takes place. These processes are represented by the Data 54, Methods 56, and Events 58 blocks of the API 52 in FIG. 4.

Components of the delegate 50 include an application-specific adaptor 60, a settings database 62, and behavior logic 64. The application-specific adaptor 60 is the part of the delegate that communicates with the application's API, so different application-specific adaptors can be used with other parts of the delegate to make these parts work with different applications. The settings database 62 further configures aspects of the delegate's behavior: for example, if the delegate is designed to be periodically activated and check for updates, the settings database might include a specific setting specifying the time that should pass between each activation and the next. The behavior logic 64 specifies the delegate's interaction with the context and with the application for which it functions as a delegate. This is where the “context awareness” is expressed. Referring to the detailed example above involving to the application composed of task management, time tracking and sales applications, the behavior logic in the time tracking application's delegate will monitors for changes in topic #3 (“what work is done”), which is part of the context. When it notices such a change, it uses the time tracking application's API to automatically record the start of a new task and the associated start time.

Applications are often developed with little, if any, detailed knowledge of other applications that the same application user might simultaneously use. Delegates typically are not developed with “knowledge” about other delegates. The apps interact via changing the data stored in the shared context. That is, when the application App1 52 changes its data, e.g., due to user action, communication, or automation, the delegate 50 translates this change into the shared context, and another application's delegate monitors changes in the shared context, and, if necessary, decides how to reflect it in the second application by activating relevant parts of second API.

In the present solution, the apps themselves are unchanged regardless of how they are embedded. If it is desired that an application behave differently, a different delegate is developed for the application.

In the embodiments described above, the delegates connect embedded apps into one integrated mobile solution. Tools using visual wizards allowing the use of a general development environment such as Microsoft Visual Studio to define, programmatically, visually or otherwise, how the delegate links shared data and actions to the app, how it decides when to initiate some action or make some suggestion, etc. Alternatively, delegates can be written “generically.” For example, the above example of a “Today's View” application requires a delegate that looks for “What/When” pairs (for example, meetings or tasks) that match the current “Who.” The same delegate could be applied to an application displaying a textual list of What/When, an application displaying calendar-like views, or a Gantt-chart application, as non-limiting examples, because all these applications, while visually quite different, interact with the shared context (and therefore interact with other applications) in a similar way.

The following is a different example for instant embedding (that is, inserting an application into a larger composite app) via generic delegates: unlike the previous example, which had several applications using the same delegate to interact with the same topic, this example uses one app but several different topics. Consider a Gantt app—one that shows “things” that have start and end times as well as an associated name (whether that name is a task, a person or an asset). Assume that it has an API for getting these “things”, and that the API also contains “events”—ways for the user to interact with one of these “things”, e.g., moving it to another date. Assume that this app is not designed to interact with the shared context using its predefined terminology.

In writing a generic delegate for this Gantt application, the code looks for topics that have start, end and related names. If the context is field service, it will find tasks. If the context is shifts scheduling, it will find shifts. If both exist, it will find both, and it may be designed to display both, in different colors; or to let the user decide; or to learn what the user wants, based on context as discussed below.

The delegate will also look within the shared context for a “time domain of interest,” such as the next day, the present day, or the present year. In this context, the terminology “time domain of interest” refers to the user's choice, which itself may be stored in the shared context for use by multiple apps. This defines what is loaded into the Gantt application. If a “time domain of interest” is not found, the delegate can use an intelligent default, such as the narrowest time range that includes all available data.

Additionally, the delegate remembers the source of information loaded into the Gantt application. Thus, any changes are incorporated into the right topic in the shared data.

Accordingly, when a Gantt application that has such a generic delegate is dropped into a solution using a “studio” program for creating composite apps, it immediately works.

In an alternate embodiment, multiple delegates interact to exhibit solution-specific behavior. More specifically, there is one application and several delegates with overrides. The one application is represented as a Gantt Instance 1 66 and a Gantt Instance 2 68 in FIG. 1. The Gantt Instance 1 66 interfaces with a generic delegate 70 and a specific delegate 1 72. The Gantt Instance 1 68 interfaces with a generic delegate 74 and a specific delegate 2 76.

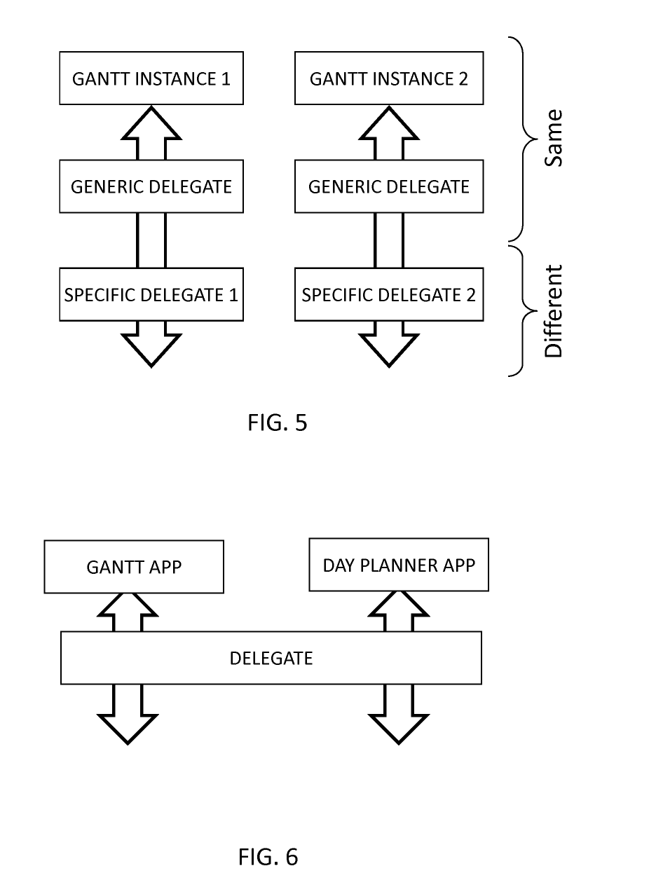

In this embodiment, the generic behavior is overridden. When a minor change is desired, instead of removing a generic delegate 70, 74 and writing a specific one, an additional and specific delegate 72, 76 is added, as illustrated in FIG. 5. In this example, the same application has both shift and task information, and a separate Gantt view for both shift and task. Accordingly, the Gantt application is dragged and dropped twice into the composite app. The generic delegates 70, 74 remain, and specific delegates 72, 76 are added as shown in FIG. 5. Specific and different behavior (e.g., data selection and workflow for changes) is added by programming or configuring the specific delegate. A rule is enforced that specific definitions override generic definitions.

In another embodiment, one delegate 78 is associated with multiple applications 80, 82. With reference to FIG. 6, consider providing the option of displaying time information in either a Gantt or a day-planner-type view, such as that provided by Microsoft Outlook. In this example, a Gantt application 82 and a day planner application 88 are two separate applications having the same API. (That is, the APIs of the two separate applications, while being physically distinct, have the same external characteristics (the same “signature”), so another program can activate either of these applications without knowing—or needing to know—with which application it is communicating.) By using the same delegate 78, whether generic or specific, the user only needs to specify once the time information to be loaded into the application, how to change that information, etc.

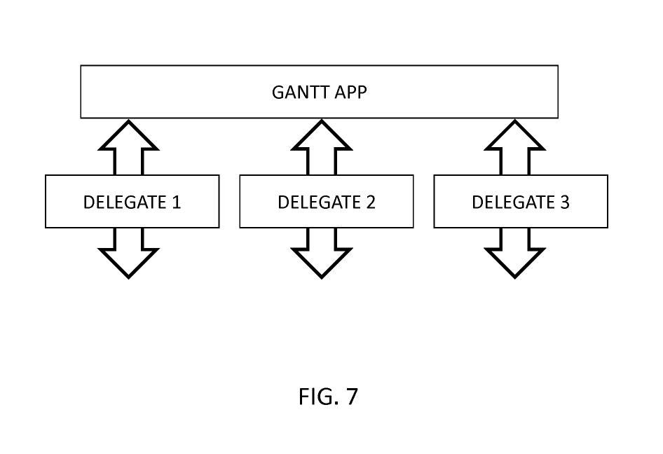

In a still further embodiment, multiple delegate specifications may be grouped logically using multiple non-overriding delegates, as illustrated in FIG. 7. In this example it is desired to be able to make different decisions regarding how the Gantt interacts with the rest of the solution depending on whether the current time is during working hours (when a dispatcher is on duty at the central office) or not during working hours (so technicians need to schedule themselves). In another example, the Gantt works with the rest of the system differently according to whether the work is during “normal weather” or during “extreme weather.” In these and similar cases, the application switches behaviors (delegates) according to context. That is, both delegates are active, but only one matches the context so only one gets activated or “triggered.”

It may be simply desired to have separate logical groupings of delegate definitions for the same application. For example, it may be desired to show both shifts and tasks on the same Gantt application 84, but there needs to be a separate set of definitions (delegates) for each. In this case, the three delegates 86, 88, and 90 shown in FIG. 7 are active, and all are triggered at the same time.

Another embodiment of the invention includes learning, self-improving delegates. The delegates learn and improve so that they react to common usage patterns that users initially perform manually. This is done using machine-learning techniques and algorithms, whether using supervised or unsupervised learning, as are known from academic and commercial research in machine learning. Such techniques include, but are not limited to, decision-tree creation, SVM (Support Vector Machines), neural networks, and Bayesian inference. The delegates then change to automatically perform some patterns, for example:

observing how the current user interacts with the current application in the same solution;

observing how the current user interacts with other applications in the same solution (or in other solutions); and

observing how other users interact with this or other applications in the same solution (or in other solutions)

To assist a delegate's “learning,” the system can be designed to provide a user the option to “Like” or “Dislike” an action performed or suggested by a delegate as a result of its learning.

In still another embodiment, a delegate functions without association to any application. Such standalone delegates monitor the context without working with a specific application. The standalone delegate can be regarded as representing the user, much as a human butler does when certain events lead to some conclusion (e.g., a human butler, when hearing about a planned gathering at the master's home, will start making the necessary purchases; similarly, a standalone delegate, on finding that the next morning's tasks require a lot of driving, may recommend filling up the vehicle's tank by the end of this work day). This is where some of the most intelligent learning may take place.

For an example of automated learning, a delegate may learn that each morning, when logging on, the user wants to add a timesheet entry, obtain the latest documents, and get the names of crew members for the day. Most often this will not be done by directly activating apps, but by setting context information so that the right apps, which monitor context changes, activate themselves.

Delegates may also be distinguished by their “owner”—a person, team, goal or community that the delegate serves, much as human butlers serve individuals, while project managers have assistant project managers, and non-profit organizations such as Parent-Teacher Associations have roles such as treasurer or secretary. Categorizing by the “owner,” we distinguish the following main types of delegates:

Customers Delegates: Delegates intended to represent and serve the needs of the organization's customer, created by an organization providing products or services to the customer of these products or services, automatically providing such actions as alerting the customer 15 minutes before start of a service, the notification of new product updates, etc.

Individualized delegates that focus on the productivity of individualized workers. Note: individualized delegates may serve regarding the worker's work tasks, regarding the worker's personal tasks (non-work-related), or regarding a combination thereof.

Corporate level delegates serving the needs of middle management that oversee a broader view of the state of the business, for example by monitoring Key Performance Indicators (KPIs) and taking steps to alert or even rectify problems noted from KPIs deviating from their target values.

Executive delegates—high level management: Similar to “Corporate level delegates for middle management” but typically operating on a strategic rather than tactical level.

Team delegates—Delegates responsible for serving the goals of one team, one community, one project etc.: For example, a delegate may be responsible for monitoring a set of tasks which a community undertakes (e.g., arranging an event), tracking the budget and the assignment of each task, and facilitating the handling of events such as a certain task being late (e.g., the task is late because the person assigned to it is otherwise occupied, and the delegate finds someone else to assign it to), over budget, etc. Note: these delegates have some overlap with corporate and executive butlers, but the teams they support may be more ad-hoc and/or transient, as well as crossing organizational boundaries.

The applications and the delegates described above run on a variety of hardware platforms and operating systems, such as computing device 10 in FIG. 1. Typical non-limiting examples include: server computers, desktop computers, laptop computers, tablets, smartphones, ruggedized computers used in challenging environmental conditions (e.g., heat, humidity, risk of dropping the computers) and dashboard-mounted computers used in vehicles. In all these types of hardware, applications may be developed to directly use the underlying operating system (usually called “native apps”), or to use a web browser environment running on top of that operating system (usually called “web apps”), or to use a hybrid of native and web development. Additionally, some of the most important apps for enterprises and consumers leverage communication networks, so that their execution and activities span many computing devices—back-end servers of various kinds as well as the portable and mobile devices mentioned above. The communication networks may be wired or wireless, confined to a circumscribed area (Local Area Networks) or spanning large territories up to the whole planet and beyond (Wide-Area Networks), and may use a large variety of communication protocols at various levels of the communication stack (e.g. TCP/IP, ATM, HTTP). Since much of the interest lies in mobile computing, where availability of communication is uncertain and where security and privacy are important considerations, the network communication mechanisms used by the apps may include “store and forward” and synchronization (so that in the absence of network access, data that needs to be sent to another computing device is stored locally until network access is regained, and then sent to the intended recipient device); encryption of data on the computing device and while being transmitted; authorization and authentication mechanisms.

Having thus described exemplary embodiments of the invention, it will be apparent that various alterations, modifications, and improvements will readily occur to those skilled in the art. Alternations, modifications, and improvements of the disclosed invention, although not expressly described above, are nonetheless intended and implied to be within spirit and scope of the invention. Accordingly, the foregoing discussion is intended to be illustrative only; the invention is limited and defined only by the following claims and equivalents thereto.

1. A computing device hosting a composite application, the computing device comprising:
a storage device having a shared context data area that receives data from at least one utility that functions independently of the composite application;
a first application having a first API and a second application having a second API, the first and second applications residing on the storage device;
a first delegate interfaces with the first API and a second delegate interfacing with the second API, the first and second delegates residing on the storage device and storing data on and retrieving data from the shared context data area; and
a processor that activates the first and second delegates to apply context awareness to determine actions based on data stored in the shared context data area and to suggest the actions to a user, to execute the actions automatically, or both;
wherein the shared context data area, the first and second applications, and the first and second delegates are components of the composite application.

2. The computing device of claim 1, wherein the shared context data area receives environmental context data.

3. The computing device of claim 1, wherein the shared context data area receives business context data.

4. The computing device of claim 1, wherein the composite application includes a third application, having a third API, and a third delegate.

5. The computing device of claim 1 further comprising:
a software design environment studio operative to insert the applications and the delegates into the composite application.

6. A computing device hosting a composite application, the computing device comprising:
a storage device having a shared context data area that receives data from at least one utility that functions independently of the composite application;
at least a first application having a first API, the first application residing on the storage device;
at least a first delegate interfacing with at least the first API, the first delegate residing on the storage device and storing data on and retrieving data from the shared context data area; and
a processor that activates at least the first delegate to apply context awareness to determine actions based on data stored in the shared context data area and to suggest the actions to a user, to execute the actions automatically, or both;
wherein the shared context data area, the first application, and the first delegate are components of the composite application.

7. The computing device of claim 6 further comprising:
an additional delegate that overrides the first delegate when interfacing with the first API.

8. The computing device of claim 6 further comprising:
a second application having a second API;
wherein the first delegate interfaces also with the second API, and the first delegate applies context awareness to determine the actions.

9. The computing device of claim 6 further comprising:
a second delegate interfacing also with the first API;
wherein the second delegate applies context awareness to determine the actions.
